(19) United States
(12) Patent Application Publication
(10) Pub. No.: US 2016/0285924 A1
(43) Pub. Date: Sep. 29, 2016

(54) COMMUNICATION CHANNEL CREATION USING SOUND STREAM

(71) Applicant: Soundover, Inc., San Jose, CA (US)

(72) Inventors: Gent Dirga, San Jose, CA (US); Hendy Eka Putra, Austin, TX (US)

(73) Assignee: Soundover, Inc., San Jose, CA (US)

(21) Appl. No.: 15/082,939

(22) Filed: Mar. 28, 2016

Related U.S. Application Data
(60) Provisional application No. 62/138,990, filed on Mar. 27, 2015.

(51) Int. Cl. H04L 29/06; G10L 25/51

(52) U.S. Cl. CPC H04L 65/1069; H04L 65/1093; H04L 65/4038; G10L 25/51

(57) ABSTRACT

Multiple devices with access to similar audio signals can join a communication channel in order to share data such as files, links, and documents. The communication channel may be created based on audio present in a geographical location of each device. Each device may receive and capture the local audio and transmit audio segment data to a server. The server may process the audio segment data to determine if audio segments for the multiple devices are considered to match within a threshold. The server identifies a moderator device of multiple devices attempting to create a communication channel. The audio signal from the moderator device is processed and used to determine which other devices should join the communication channel. The present technology allows users within a geographical location to quickly and securely join a communication channel and easily identify a moderator and participants of the communication channel.

### CROSS REFERENCE TO RELATED APPLICATIONS

This application claims the priority benefit of U.S. Provisional Application Ser. No. 62/138,990, titled “Communication Channel Creation Using Sounds Stream,” filed Mar. 27, 2015, the disclosure of which is incorporated herein by reference.

### BACKGROUND

Sharing online data among a group of devices requires the operators of the devices to request for contact information from other members such as email addresses and/or phone numbers and/or usernames, which may result in inconvenience, errors/typos, and/or even privacy issues. Prior solutions include various chatting applications or web conference services, which requires users to connect through an invitation process, usually by sending a unique URL (often very long) via emails or phones. Yet, these solutions may still require end users to share their contact information.

Other solutions include a near-field communication technology such as RFID, which requires group members to be in the same location at a very close range. This method is not practical for a large group of people and not possible if they are not in the same location (e.g., conference calls).

What is needed is an improved manner for sharing online data among a group of devices.

### SUMMARY

The present technology allows multiple devices with access to similar audio signals to join a communication channel in order to share data such as files, links, and documents. The communication channel may be created based on audio present in a geographical location of each device. Each device may receive and capture the local audio and transmit the audio segments to a remote server. The server may process the audio to determine if the audio segments for the multiple devices are considered to match within a threshold. The server identifies a moderator device of multiple devices attempting to create a communication channel. The audio signal from the moderator device is processed and used to determine which other devices should join the communication channel. The present technology allows users within a geographical location to quickly and securely join a communication channel and easily identify a moderator and participants of the communication channel.

In an implementation, a method of the present technology may create a communication channel. A first audio segment data is received by a server from a first device, wherein the first audio segment data associated with an audio stream. A second audio segment data is received by a server from a second device, wherein the second audio segment data containing a subset of the audio stream. A first signature associated with the first audio segment data may be accessed, and a second signature associated with the second audio segment data may be accessed. A communication channel may be created by the server between the first device and the second device based on a comparison of the first signature and the second signature.

An implementation may include a system for monitoring a business transaction. The system may include a server having a processor, memory, and one or more modules stored in memory and executable by the processor. When executed, the modules may receive a first audio segment data by a server from a first device, the first audio segment data associated with an audio stream, receive a second audio segment data by a server from a second device, the second audio segment data containing a subset of the audio stream, access a first signature associated with the first audio segment data, access a second signature associated with the second audio segment data, and create a communication channel by the server between the first device and the second device based on a comparison of the first signature and the second signature

### BRIEF DESCRIPTION OF THE DRAWINGS

FIG. 1 illustrates a block diagram of a system for creating communication channels based on audio data.

FIG. 2 illustrates a block diagram of an exemplary computing device.

FIG. 3 illustrates a block diagram of an exemplary server.

FIG. 4 illustrates an exemplary method for creating a communication channel based on audio data.

FIG. 5 illustrates an exemplary method for capturing a streaming audio signal.

FIG. 6 illustrates an exemplary method for processing audio segments.

FIG. 7 illustrates an exemplary method for identifying a moderator device.

FIG. 8 illustrates a block diagram of an exemplary computing system for implementing the present technology.

### DETAILED DESCRIPTION

The present technology allows multiple devices with access to similar audio signals to join a communication channel in order to share data such as files, links, and documents. The communication channel may be created based on audio present in a geographical location of each device. Each device may receive and capture the local audio and transmit the audio segments to a remote server. The server may process the audio to determine if the audio segments for the multiple devices are considered to match within a threshold. The server identifies a moderator device of multiple devices attempting to create a communication channel. The audio signal from the moderator device is processed and used to determine which other devices should join the communication channel. The present technology allows users within a geographical location to quickly and securely join a communication channel and easily identify a moderator and participants of the communication channel.

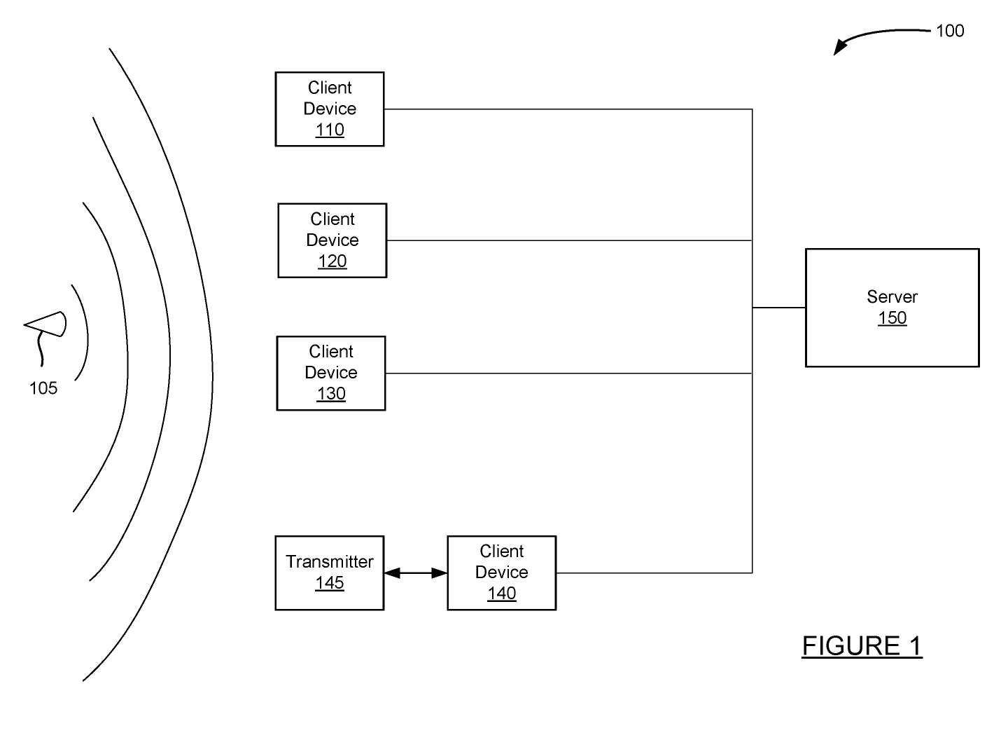

FIG. 1 illustrates a block diagram of a system for creating communication channels based on audio data. The system of FIG. 1 includes audio source 105, client devices 110, 120, 130 and 140, transmitter device 145, and server 150. Each of client devices 110, 120 and 130 may be located within the same geographical location as audio source 105. Audio source 105 may provide audio that may be detected by one or more microphones from each of clients 110-130. The audio may include a human speaker, music, a series of tones, ambient environment noise, or other audio in the geographical location of clients 110-130. In some implementations, audio source 105 may include speech by a user of one of clients 110-130. In some implementations, audio 105 may include audio that is output by one of clients 110-130.

Client 140 may receive the audio stream provided by audio source 105 through transmitter 145. As such, client 140 may not be an immediate geographical location of clients 110-130, but may receive audio present in the geographical location as client devices 110-130 through transmitter device 145. Transmitter device may be a phone, radio, television, or other device capable of receiving audio and transmitting the audio to a remote device.

As each of clients 110, 120, 130 and 140 receive an audio stream from audio source 105, they may each process the audio to divide the incoming audio stream into segments. The length of each segment may be determined based on the processing power of the client, the communication speed of the clients with server 150, and other factors. In some embodiments, an audio segment may be 1 second, 2 seconds, 3 seconds, or some other time period. Each client device may transmit audio segments to server 150. The segments may be transmitted continuously for a set period of time or until an instruction is received from server 150 to stop transmitting audio segments.

Server 150 may receive one or more segments from each of client devices 110-140 and may process the segments. Each received segment is processed such that it may be added to other segments received from the particular client. In some implementations, each segment received from a client is associated with either a client identifier, a session identifier associated a communication session between a client device and the server, or some other data that allows multiple segments received from a particular client device to be patched together.

Server 150 may process a group of patched audio segments to identify parameters for the set of segments. The parameters may include a signature generated from the set of audio segments. In some implementations, the signature may be generated based on a maximum amplitude detected within each of a series of frequency bands that form the audio segment. For example, for an audio frequency range of 20 Hz to 20,000 Hz, the set of audio segments may be divided into 20 frequency bands of 1 kHz each, with the maximum amplitude being recorded for each 1 kHz band. The signature would then consist of an array of amplitude values associated with the number of frequency bands. After identifying a signature for a set of bands, the signature is stored by the server and compared to subsequent audio segment signatures generated from audio segments received from other client devices. In some implementations, the signature may be generated based on the absolute or relative time stamps of when certain peaks are detected within the set of audio segments. The comparison may include determining if the signature, or other data generated from as set of one or more audio segments, matches a signature or other data generated from another set of one or more audio segments within a threshold. The threshold may be implemented as a probability determination such as for example an 85% probability of being the same, a percentage value such as for example a 90% match, or some other threshold value.

Of the client devices that provide a server one or more segments of audio data, a signature, or other data for comparison, one of the clients is selected as a moderator, and other clients having audio segment signatures that match the audio segment signature of the moderator are added to a communication channel associated with the moderator. Server 150 then creates the communication channel and adds selected client devices to the communication channel as appropriate.

In some implementations, a signature or other data created from one or more audio segments may be generated at the client device. In this case, the signature or other data may merely be transmitted to a server and compared at a server to determine if the signatures or other data created from the one or more audio segments match within a threshold.

In some implementations, a server may be implemented in the client device. For example, the server may be implemented as a home automation hub that can act as both a client and a server. When a server is implemented in a client device, a portion or all of the functionality of the server may be implemented in the client device rather than on a remote machine.

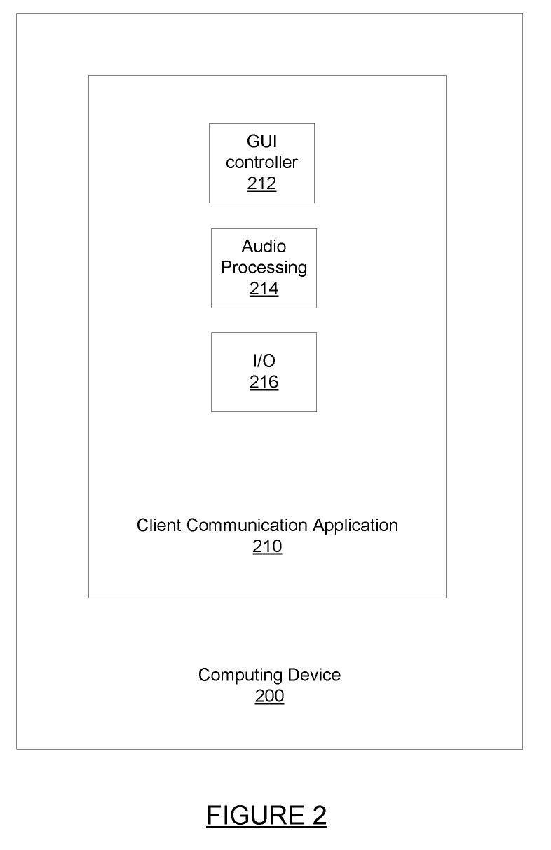

FIG. 2 illustrates a block diagram of an exemplary computing device. The computing device of FIG. 2 provides more detail for clients 110, 120, 130, 140. Computing device 200 of FIG. 2 may include a client communication application 210. The client communication application may implement a communication channel from the client device. Application 210 may include graphical user interface (GUI) controller 212, audio processing module 214, and input output module 216. GUI controller 212 may provide a GUI for display through a display component of a computing device 200. The GUI provided by controller 212 may have one or more graphical interfaces that allow a user to initiate a communication channel, initiate the capture of audio at the computing device, request to join a communication channel, exit or otherwise leave a communication channel already joined, and exchange data such as links, pictures, audio, and documents within a communication channel.

Audio processing module 214 may operate and control one or more microphones on a client device to capture audio. Captured audio may include an audio stream present at the geographical location of the particular client device. Once captured, audio processing module 214 may separate the captured audio stream into a series of segments. Each segment may then be provided to I/O module 216 for transmission to a remote server, such as for example server 150.

Client communication application 210 may include additional logic for processing input received through an interface, preparing messages to transmit to remote machines such as server 150, and perform other tasks. Listing of modules 212-216 is exemplary for carrying out the functions described herein. It is intended that the illustrated modules may perform additional functionality and/or additional modules may be included within client communication application 210 (not illustrated in FIG. 2).

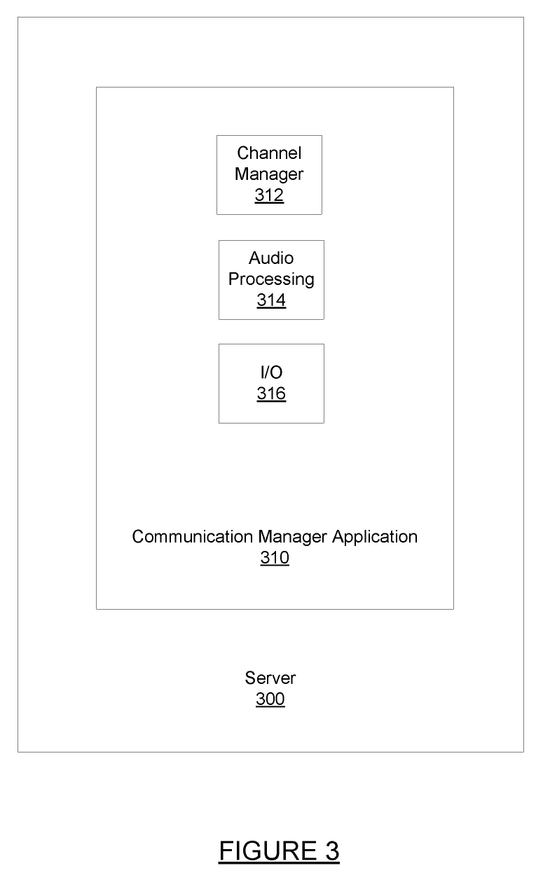

FIG. 3 illustrates a block diagram of an exemplary server. Block diagram of FIG. 3 may provide more detail for server 150 of FIG. 1. Server 300 of FIG. 3 may include communication manager application 310. Application 310 may include channel manager 312, audio processing module 314, and I/O module 316. Channel manager 312 may include logic for comparing audio segment signatures, creating a communication channel, labeling a client device as a moderator of a communication channel, adding participants' devices to a communication channel, and otherwise tracking and managing client devices which are part of a communication channel.

Audio processing module 314 may receive one or more audio segments from a remote device, such as client devices 110-140, combine the audio segments for each client device into a string of audio segments, and process the audio segments to identify a signature of the set of audio segments. I/O module 316 may receive audio segments and other data from clients 110-140 and may transmit instructions, messages, and data to clients 110-140.

Communication Manager Application 310 may include additional logic for processing received audio segments received from remote client devices 110-140, generating and managing moderator devices, participant device, and communication channels, and perform other tasks. The illustration and discussion of modules 312-216 is exemplary for carrying out the functions described herein. It is intended that the illustrated modules may perform additional functionality and/or additional modules may be included within Communication Manager Application 310 (not illustrated in FIG. 3).

As discussed herein, the functionality of server 300 may be implemented in a client device. As such, application 210 and modules 312-316, as well as other functionality typically performed by such a server, may be implemented in a client device such as client devices 110-140 and/or client device 200.

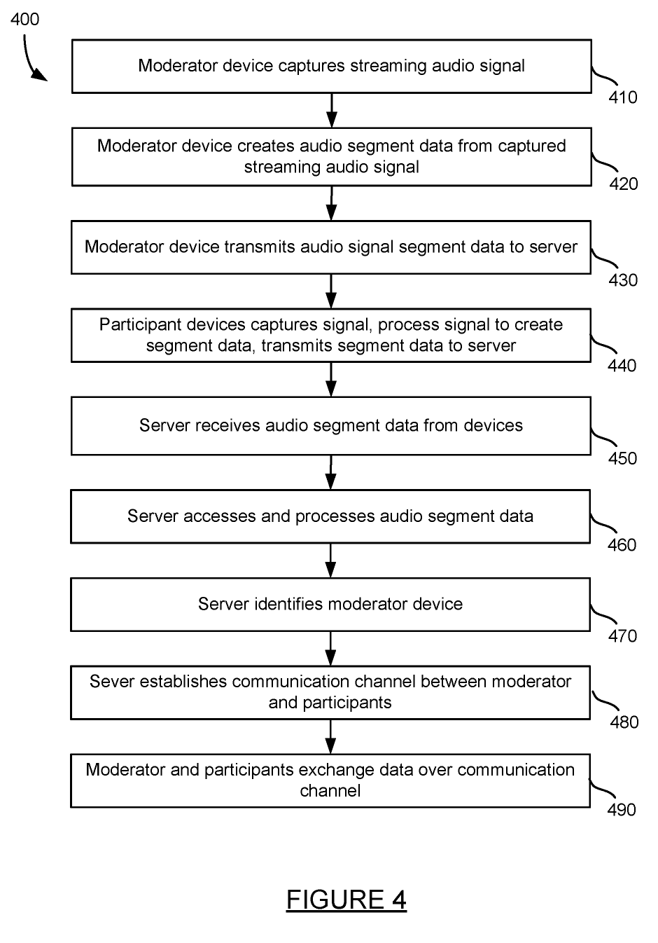

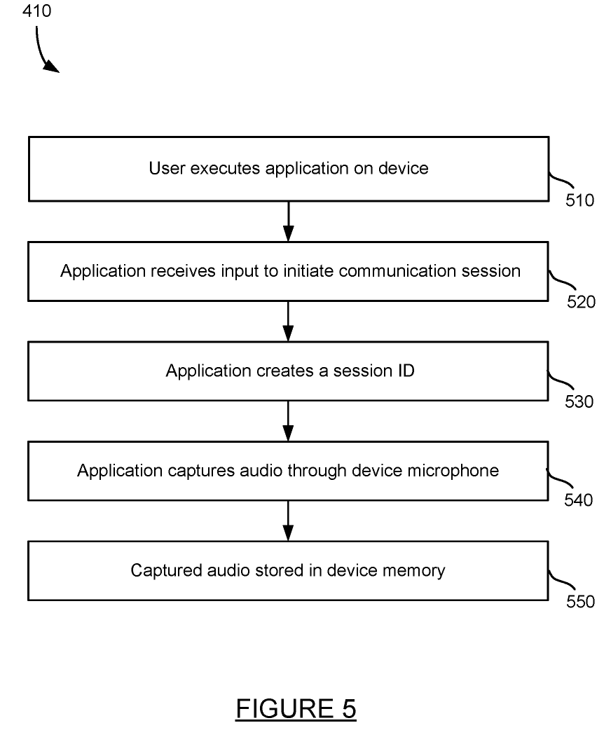

FIG. 4 illustrates an exemplary method for creating a communication channel based on audio data. A moderator device may capture a streaming audio signal at step 410. A process of capturing a streaming audio signal by a client device may include a user of the client device opening an application, initiating a sound recording through the application, and the application proceeding to record streaming audio. The audio may include environment audio, audio generated by a user of the device, audio generated by the device itself, or some other audio they can be picked up by one or more microphones in the device executing application. Capturing a streaming audio signal by a moderator device that is discussed in more detail below with respect to the method of FIG. 5.

The moderator device may create audio segment data from the captured streaming audio signal at step 420. As the streaming audio signal is received by the microphones and converted to digital data, the streaming audio signal may be divided into segments. Each segment of audio may be stored in memory on the device. The moderator device may then transmit audio segment data that includes the audio signal segments to a remote server at step 430. The audio segments may be sent individually or in groups of two or more to server 150 over a network. The network may include a Wi-Fi network, wireless network, wired network, cellular network, local area network, wide-area network, a public network such as the Internet, a private network, or a combination of these networks. Part of transmitting the audio signal segments to remote server may include establishing a communication session between the particular device and the server 150. The communication session may be established, for example, as an asynchronous connection. Once the connection is established, the one or more audio segments may be transmitted via a digital data connection, such as a TCP/IP, UDP, or other data connection to the server.

In some implementations, the moderator device may generate one or more signatures from the one or more audio segments and transmit audio segment data that includes the one or more signatures for the one or more sets of audio segments to the server.

Similar to the moderator device, participant devices may capture an audio signal, process the signal to create audio segment data, which may include one or more audio segments and/or one or more signatures generated from one or more audio segments, and transmit the audio segment data to a remote server 150 at step 440. Unlike the moderator device, a participant devices may join a communication channel that has already been created or initiated by the moderator device.

The server receives audio segment data from one or more devices at step 450. The audio segment data received from the devices may be associated with different time periods. For example, a client device serving as a moderator device may transmit audio segment data prior to one or more participant devices transmitting audio segment data to server 150. As such, server 150 may asynchronously receive various audio segment data from different client devices.

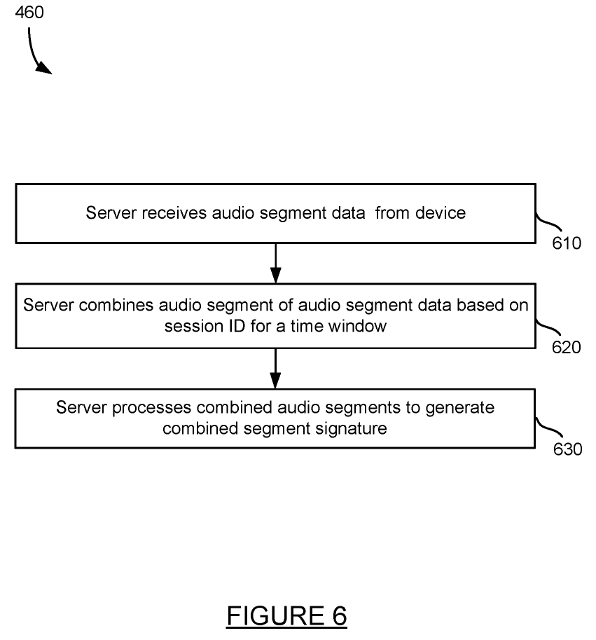

Server 150 may access and process the audio segment data at step 460. The server may access the audio segment data from memory, cache or directly from one or more devices. Processing the audio segment data may include combining the one or more audio segments and generating a combined segment signature for a set of audio segments. In some instances, when the received audio segment data includes one or more signatures, accessing and processing the audio segment data may merely include accessing the one or more signatures from the audio segment data received. Processing audio segments by server 150 is discussed in more detail below with respect to the method of FIG. 6.

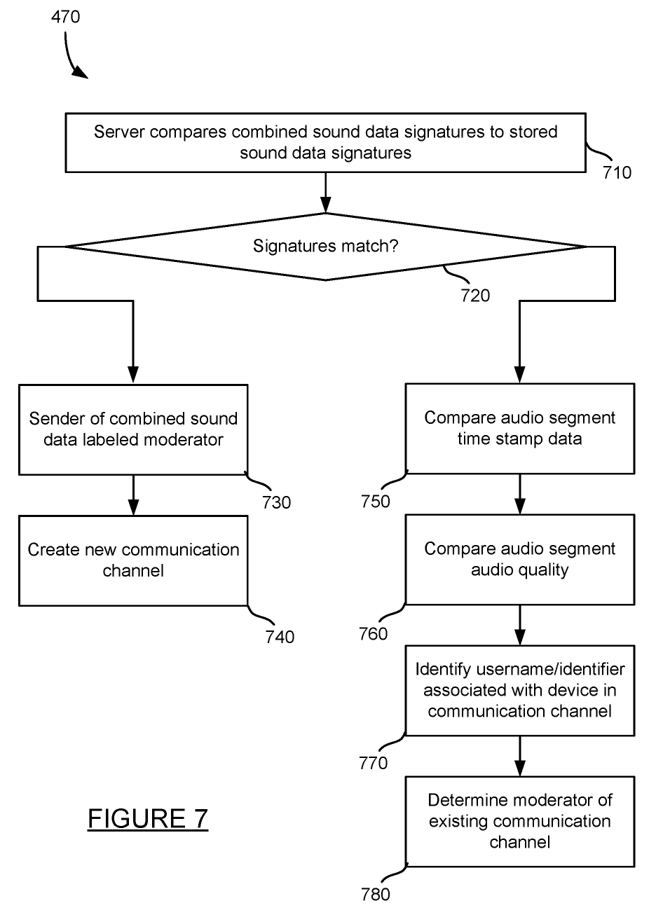

A moderator may be identified by server 150 from a collection of devices attempting to join a communication channel at step 470. A moderator may be selected based on audio segment timestamp data, audio segments quality, and identifier associate with a particular device, or other factors. The moderator device may be the first device to capture the streaming audio, have the clearest and best quality audio signal transmitted to server 150, may include a session identifier or communication channel identifier, or may be otherwise identified. Selecting a moderator between a group of client devices is discussed in more detail below with respect to step 470 and the method of FIG. 7. Identifying a moderator device by server is discussed in more detail below with respect to the method of FIG. 7.

The server establishes a communication channel between a selected moderator device and participant devices at step 480. The communication channel may be created for a number of devices that have been determined to have received one or more audio segments having a signature that matches or satisfies a similarity threshold. For example, once a moderator is selected, the audio segment signature associated with the moderator may be compared to audio segment signatures of each potential participant device attempting to join the communication channel associated with the moderator device. If a participant device audio segment signature matches the moderator device audio segment signature, the participant device may join the communication channel associated with the moderator device. The communication channel may allow a moderator device and participant devices to exchange data over the communication channel at step 490. To exchange data, the device may receive selection of data to share through a graphical user interface provided through the device to a user. Hence, a user may use a graphical user interface provided by application 210 to select data to share with other devices within the communication channel. In some instances, the selected data may be shared prior to creation of the communication channel so it can be immediately available to other devices as soon as they join the communication channel. Data cited by a user, such as an image, audio, document, file, text, or other data is transmitted to server 150 by the particular device. The data is then distributed by server 150 to selected devices or all other devices, including the moderator device and any participant devices, within the communication channel.

In some implementations, as discussed above, data sent by a client to the server may include audio segment data. The audio segment data may include audio segments (i.e., segments of raw audio) or signatures of a set of audio segments. Hence, the client may send one or more audio segments themselves or one or more signatures of the audio segments (collectively referred to as “audio segment data”) to a server. Further, the server may be implemented on a machine remote from the client or the same machine or device as the client.

FIG. 5 illustrates an exemplary method for capturing a streaming audio signal. The method of FIG. 5 provides more detail for step 410 of the method of FIG. 4. A user may execute an application on a device at step 510. The application may include the client communication application 210 discussed with respect to the system of FIG. 2. Executing the device may include selecting the device to be opened on a user's smart phone, mobile device, laptop computer, desktop computer, tablet, or any other device.

The application may receive input to initiate a communication session at step 520. The executing application may receive input through a graphical user interface, input device, or some other input mechanism to start a communication session. Receiving input may include receiving selection of a graphical user interface button to initiate a communication channel, detecting an action by sensor, such as for example a shake of a mobile device, to initiate a session, or otherwise receive input to initiate a communication session by the application.

In some implementations, the input received at step 520 may be to join an existing communication session. In this case, the input is received by the application in a similar manner, such as for example an input received through a graphical user interface provided on a display of a smart phone or other mobile device.

The application may create a session ID at step 530. The session ID will be used to communicate with a remote server 150 in order to initiate a communication session. In some implementations, the session ID is associated with the client device and the server, and is used for the duration of the processing the request for a communication channel only—the session ID may not be used during implementation of the communication channel. The session ID may be generated based on static and dynamic data, such as for example a user name, user password, a device identifier for the device being used to communicate with server 150, timestamp and date stamp data, and other data.

The application may capture audio through a microphone on the user's device at step 540. The audio include ambient noise present in the environment, audio from a user of the device at which the communication session is initiated or attempting to join, audio created by the user's device, or other audio. The captured audio may be stored in device memory at step 550. The stored audio may be processed to generate segments of audio which will be transmitted to server 150 as discussed respect to step 420 of the method of FIG. 4.

FIG. 6 illustrates an exemplary method for processing audio segment data. The method of FIG. 6 provides more detail of step 460 of the method of FIG. 4. The method of FIG. 6 describes processing one or more audio segments within audio segment data at a server to generate a signature. In some implementations, one or more audio segments may be processed at a client device to generate a signature. The signature may then be provided to and processed at a server. As such, the description of processing audio segments by a server is not intended to be limiting, and it is intended that the processing of audio segments may be performed at a client device as well as a server.

Server 150 may receive segments from a particular device at step 610. Each received segment may include an identifier, such as for example a session identifier, username, device identifier, and/or another identifier, which the server may use to group audio segments received from a particular device.

In some instances, data received by the server may include audio segment data. The audio segment data may include audio segments themselves (i.e., segments of raw audio) or signatures of a set of audio segments. Hence, the client may send one or more audio segments themselves or one or more signatures of the audio segments (collectively referred to as “audio segment data”) to a server. Further, the server may be implemented on a machine remote from the client or the same machine or device as the client.

The server may combine the segments based on the identifier for a particular time window at step 620. In some instances, the server may continually modify a group of audio segments received from a particular client device based on a moving time window. Hence, as time proceeds, the segments included in the rolling time window will be continually updated by server 150. The segments may be joined based on timestamp data associated with each segment and the identifier associated with a particular segment that indicates the source of the segment, such as a particular device.

Server 150 processes the combined audio segments to generate a combined segment signature at step 630. Server 150 may process audio segments that fall within a sliding time window. The segments within the current time window may be processed to generate a signature.

Audio signatures may be generated and a variety of ways. The purpose of the audio signature is to enable server 150 to identify if audio segments received from another device match audio segments from the particular device for the particular time window. The audio signature may be determined as any value, an array of values, or other representation allows comparison between two sets of audio data. For example, an audio signal may be divided into a plurality of bands, and the audio signature may be generated by calculating the maximum amplitude within each band, providing an audio signature consisting of a series of amplitudes for each set of audio segments. Once an audio signature is generated, the signature is stored by the server in local memory or other accessible memory.

FIG. 7 illustrates an exemplary method for identifying a moderator device. The method of FIG. 7 provides more detail for step 470 the method of FIG. 4. A server may compare a stored audio signature to a signature for combined audio segments from a particular device at step 710. A determination may then be made as to whether the signatures match at step 720. If the signatures do not match, the device associated with the signature that did not match any stored signature is labeled as a moderator at step 730. Hence, the center of the signature for the combined set of audio segments did not match a signature associated with an existing communication channel, so the device was named as moderator of a new communication channel. A new communication channel is created at step 740. The center of the combined sound data is labeled as a moderator of the new communication channel created at step 740.

Returning to step 720, if the signatures of the combined segments for the particular device match one or more signatures stored in memory, one or more steps may be taken to determine which of the two or more devices associate with a signatures should be labeled as the moderator of a communication channel. Audio segment timestamp data may be compared at step 750. In some implementations, the set of audio segments having the earliest timestamp may be selected as a moderator. In some implementations, audio segment quality is compared at step 760. Audio segments having a better quality, such for example less background noise in in one or more frequency bands of the audio segments, may be selected as moderator in order to facilitate better comparisons for other signatures to the clearer audio segment signature. In some implementations, the user name or identifier associated with the device and the communication channel may be identified at step 770. When a user decides to start a communication channel, user may provide input to a device through a graphical user interface to initiate a communication channel as a moderator. In this situation, a username for the user or device identifier may be included with audio segments to identify the user or device as a moderator of a particular communication channel.

In addition to the comparisons of steps 750-770, data received from one or more sensors on one more devices may be received. For example, a server may receive geographical positioning sensor data such as Global Positioning System (GPS) data from each device to determine the location of each device.

Based on one or more of the comparisons of steps 750-770, and optionally additional sensor data, the moderator of the existing communication channel may be determined at step 780.

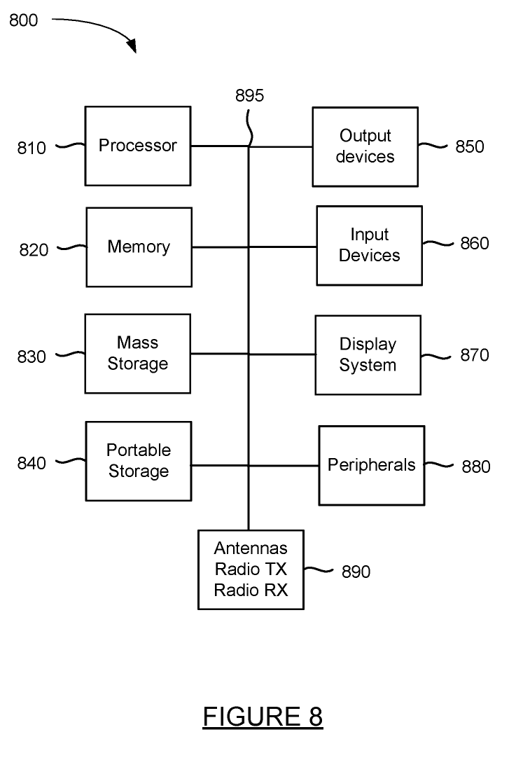

FIG. 8 illustrates a block diagram of an exemplary computing system for implementing the present technology. System 800 of FIG. 8 may be implemented in the contexts of the likes of client devices 110, 120, 130, and 140, transmitter 145, and server 150. The computing system 800 of FIG. 8 includes one or more processors 810 and memory 820. Main memory 820 stores, in part, instructions and data for execution by processor 810. Main memory 820 can store the executable code when in operation. The system 800 of FIG. 8 further includes a mass storage device 830, portable storage medium drive(s) 840, output devices 850, user input devices 860, a graphics display 870, and peripheral devices 880.

The components shown in FIG. 8 are depicted as being connected via a single bus 890. However, the components may be connected through one or more data transport means. For example, processor unit 810 and main memory 820 may be connected via a local microprocessor bus, and the mass storage device 830, peripheral device(s) 880, portable storage device 840, and display system 870 may be connected via one or more input/output (I/O) buses.

Mass storage device 830, which may be implemented with a magnetic disk drive, an optical disk drive, a flash drive, or other device, is a non-volatile storage device for storing data and instructions for use by processor unit 810. Mass storage device 830 can store the system software for implementing embodiments of the present invention for purposes of loading that software into main memory 820.

Portable storage device 840 operates in conjunction with a portable non-volatile storage medium, such as a floppy disk, compact disk or Digital video disc, USB drive, memory card or stick, or other portable or removable memory, to input and output data and code to and from the computer system 800 of FIG. 8. The system software for implementing embodiments of the present invention may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, a pointing device such as a mouse, a trackball, stylus, cursor direction keys, microphone, touch-screen, accelerometer, and other input devices Additionally, the system 800 as shown in FIG. 8 includes output devices 850. Examples of suitable output devices include speakers, printers, network interfaces, and monitors.

Display system 870 may include a liquid crystal display (LCD) or other suitable display device. Display system 870 receives textual and graphical information, and processes the information for output to the display device. Display system 870 may also receive input as a touch-screen.

Peripherals 880 may include any type of computer support device to add additional functionality to the computer system. For example, peripheral device(s) 880 may include a modem or a router, printer, and other device.

The system of 800 may also include, in some implementations, antennas, radio transmitters and radio receivers 890. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth devices, and other radio frequency networks. The devices may include one or more radio transmitters and receivers for processing signals sent and received using the antennas.

The components contained in the computer system 800 of FIG. 8 are those typically found in computer systems that may be suitable for use with embodiments of the present invention and are intended to represent a broad category of such computer components that are well known in the art. Thus, the computer system 800 of FIG. 8 can be a personal computer, hand held computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, iOS, Android, as well as various programming languages such as C, C++, Node.JS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for creating a communication channel, the method comprising:
receiving a first audio segment data by a server from a first device, the first audio segment data associated with an audio stream;
receiving a second audio segment data by a server from a second device, the second audio segment data containing a subset of the audio stream;
accessing a first signature associated with the first audio segment data;
accessing a second signature associated with the second audio segment data; and
creating a communication channel by the server between the first device and the second device based on a comparison of the first signature and the second signature.

2. The method of claim 1, wherein the first audio segment data and second audio segment data each include one or more audio segments, wherein the first signature is generated from one or more audio segments associated with the first device and the second signature is generated from one or more audio segments associated with the second device.

3. The method of claim 1, wherein the first audio segment data includes a first audio signature and the second audio segment data includes the second audio signature.

4. The method of claim 1, wherein the server is remote from the first device and the second device.

5. The method of claim 1, wherein the server is implemented within the first device.

6. The method of claim 1, wherein the first device and the second device are geographically near a source of the audio stream.

7. The method of claim 1, wherein a third device is added to the communication channel, the third device remote from the first device and the second device and receiving a transmission of the audio stream.

8. The method of claim 1, wherein the server selects one of the first device and the second device as a moderator device.

9. The method of claim 1, further comprising determining if the signature for the audio segments received from the non-moderator device matches the signature for the audio segments received from the moderator device.

10. The method of claim 9, wherein the selection of the moderator device is based on audio segment time stamp data.

11. The method of claim 9, wherein the selection of the moderator device is based on audio segment quality.

12. The method of claim 9, wherein the selection of the moderator device is based on a moderator identifier.

13. The method of claim 1, wherein the signature is generated from a plurality of bands that make up the audio segments.

14. The method of claim 1, wherein the signature is generated from time stamps of a plurality of peaks detected within the audio segments.

15. The method of claim 1, wherein the segments are received individually by the server and combined into a single audio file associated with the transmitting client device by the server

16. The method of claim 1, wherein creating a communication channel further includes:
determining there is no match between the first signature and the second signature, and
creating a new communication channel with the first device as the moderator device.

17. The method of claim 1, wherein creating a communication channel further includes:
determining there is a match between the first signature and the second signature, and
adding the second device to the communication channel associated with the first device.

18. The method of claim 1, further comprising comparing sensor data received from one or more sensors on each of the first device and the second device.

19. A non-transitory computer readable storage medium having embodied thereon a program, the program being executable by a processor to perform a method for creating a communication channel, the method comprising:
receiving a first audio segment data by a server from a first device, the first audio segment data associated with an audio stream;
receiving a second audio segment data by a server from a second device, the second audio segment data containing a subset of the audio stream;
accessing a first signature associated with the first audio segment data;
accessing a second signature associated with the second audio segment data; and
creating a communication channel by the server between the first device and the second device based on a comparison of the first signature and the second signature.

20. The non-transitory computer readable storage medium of claim 19, wherein the audio segment data includes one or more audio segments.

21. The non-transitory computer readable storage medium of claim 19, wherein the audio segment data includes an audio signature

22. The non-transitory computer readable storage medium of claim 19, wherein the server is remote from the first device and the second device.

23. The non-transitory computer readable storage medium of claim 19, wherein the server is implemented within the first device.

24. A system for creating a communication channel, comprising:
a server including a memory and a processor; and
one or more modules stored in the memory and executed by the processor to receive a second audio segment data by a server from a second device, the second audio segment data containing a subset of the audio stream, access a first signature associated with the first audio segment data, access a second signature associated with the second audio segment data, and create a communication channel by the server between the first device and the second device based on a comparison of the first signature and the second signature.
